(19) United States
(12) Patent Application Publication
(10) Pub. No.: US 2014/0083305 A1
(43) Pub. Date: Mar. 27, 2014

(54) Baby Food Processor

(71) Applicant: Yu-Yuan Lin, Tainan (TW)

(72) Inventor: Yu-Yuan Lin, Tainan (TW)

(21) Appl. No.: 13/628,095

(22) Filed: Sep. 27, 2012

(51) Int. Cl. A47J 27/04; A47J 44/02

(52) U.S. Cl. 99/353

(57) ABSTRACT

The present invention provides a baby food processor capable of cooking and blending or grinding baby food, and during the cooking process of the food, the water vapor generated by the boiled water in the water tank provided on one side of the food processor is guided into the cup holder containing the food to achieve an efficient cooking and to facilitate the pre-blending or grinding thereof afterwards.

### BACKGROUND OF THE INVENTION

1. Technical Field

The present invention is related to a baby food processor, in particular, to a food processor capable of cooking and blending or grinding baby food, and during the cooking process of the food, the water vapor generated by the boiled water in the water tank provided on one side of the food processor is guided into the cup holder containing the food to achieve an efficient cooking and to facilitate the pre-blending or grinding thereof afterwards.

2. Description of Related Art

Currently, there are various designs and types of different baby food processors. Basically, baby food processors are designed to cook various kinds of food and to blend as well as grind the cooked food afterwards to facilitate the consuming or eating of the food by babies.

U.S. Pat. No. 6,076,452 discloses a food processor for baby food and the food processor is provided for cooking the food, grinding or blending the already-cooked food with cutting blades in order to complete the baby food in the desired form.

However, this type of baby food processor includes complicated components difficult for the assembly of the processor while being bulky in size and occupying a large space, causing its use and operation to be inconvenient.

### BRIEF SUMMARY OF THE INVENTION

The present invention provides an improved baby food processor in light of overcoming the complicated components involved overall and the inconvenient assembly thereof such that during the cooking of the food, the food processor is able to utilize the water vapor guided into the cup containing the food therein for efficient cooking, facilitating the pre-blending or grinding of the food afterwards. In addition, the overall structure of the food processor is simplified to involve less components and to allow fast assembly as well as to facilitate the storage of the food processor not in use without occupying large spaces as a whole.

A first objective of the present invention is to provide a baby food processor comprising a main body and a main body and a grinder/cooking cup assembly; wherein a bottom portion of said main body comprises a motor having an axle protruding outward from a predefined hole on a top of said main body, a water tank is provided on a predefined circumference at an internal of said main body, a side inlet of said water tank corresponds to a water-pouring entrance on said top of said main body for a tank cap press-fitted therein, an electric heating pipe is attached to a bottom of said water tank, and a lower opening of said main body is directionally secured onto a base; and wherein said blending/cooking cup assembly comprises a bottom slot formed on a bottom portion of a cup and engaged against a corresponding circular protruding edge on said top of said main body, a cutting blade is inserted from a top opening of said cup and attached onto said motor axle protruding outward on said top of said main body, and a lid covering said top opening of said cup; characterized in that: said water tank attached to said internal of said main body comprises a predefined water vapor outlet adjacent to a top end thereof, a water vapor conduit formed in a top-down direction is provided on a lateral circumference of said cup, and said conduit extends to an inner outlet of a side handle of said cup and said inner outlet corresponds to a predefined hole on said lid; whereby, water filled into said water tank inside said main body is heated and boiled by said electric heating pipe to generate water vapor capable following said outlet on one end of said water tank into said conduit on one side of said cup and further into an internal of said cup via said hole provided on said lid in order to cook food contained therein.

A second objective of the present invention is that said water vapor conduit formed on said lateral circumference of said cup adjacent to said top end thereof is directionally connected to said side handle with said inner outlet adjacent to said top of said cup and penetrating an inner side of said side handle formed in two halves such that said water vapor conduit is guided to exit from said side handle.

A third objective of the present invention is that said main body attached with said water tank further comprises a notch formed adjacent to said water vapor outlet on said top of said main body such that a section of said conduit on one side of cup is connected firmly thereto.

A fourth objective of the present invention is that one side of said water tank attached to said internal of said main body comprises a transparent viewing window corresponding to a predefined transparent slot provided on said main body for viewing a water level in said water tank.

### BRIEF DESCRIPTION OF THE DRAWINGS

FIG. 1 is an exploded view of the baby food processor of the present invention;

FIG. 2 is a perspective view of the baby food processor of the present invention prior to its use;

FIG. 3 is a perspective view of the baby food processor of the present invention during its use;

FIG. 4 is an illustration showing related components of the water vapor guidance of the baby food processor of the present invention; and

FIG. 5 is a directional guidance of the water vapor of the baby food processor of the present invention.

### DESCRIPTION OF EMBODIMENTS OF THE INVENTION

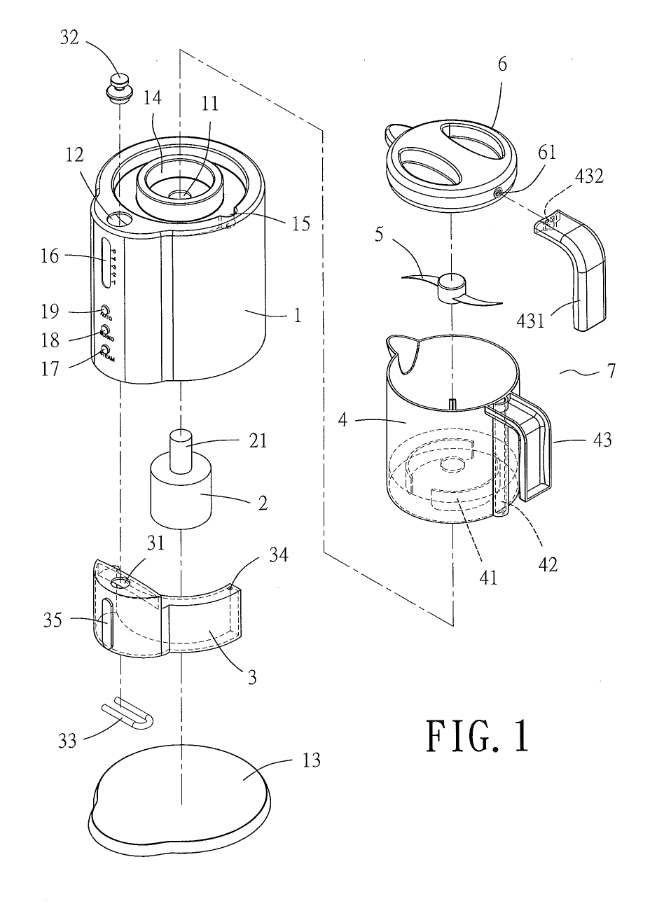

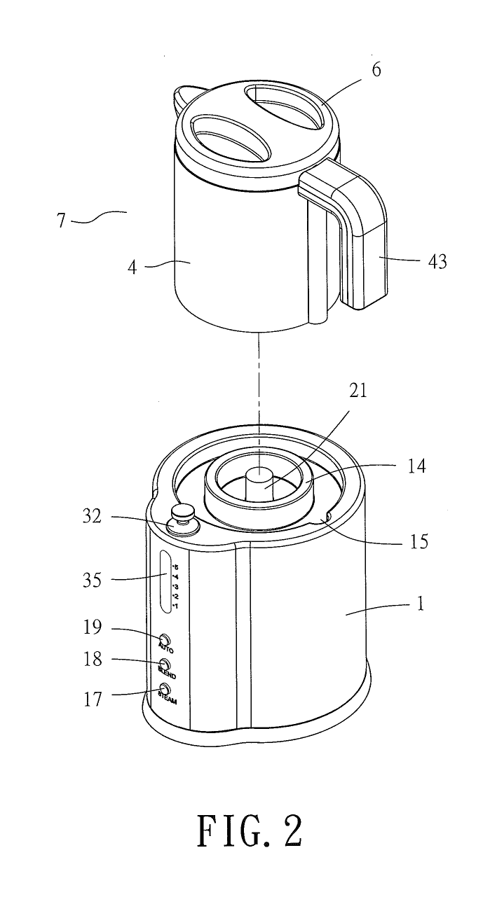

The present invention provides a baby food processor, as shown in FIGS. 1 and 2, mainly used for processing baby food, and said baby food processor comprises a main body 1 and a grinder/cooking cup assembly 7, which also includes the following features.

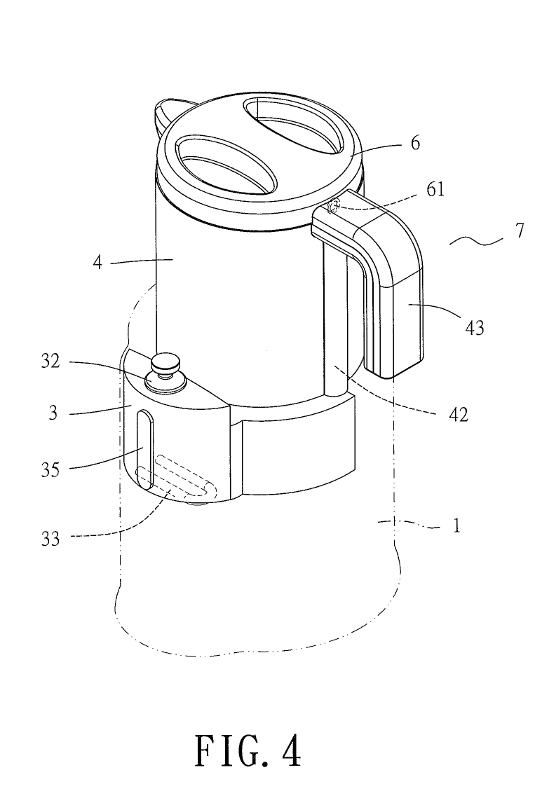

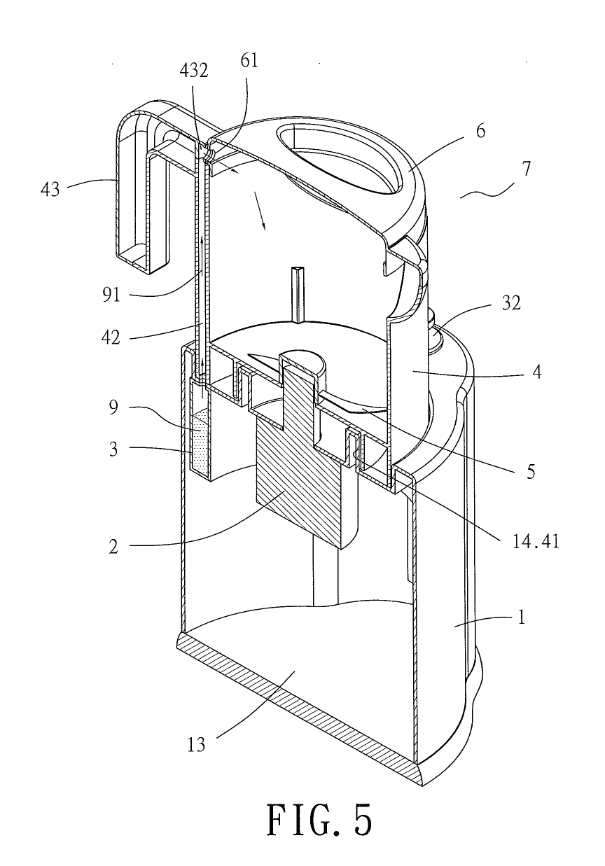

A bottom portion of said main body 1 comprises a motor 2 having an axle 21 protruding outward from a predefined hole 11 on a top of said main body 1, as shown in FIG. 5. A water tank 3 is provided on a predefined circumference at an internal of said main body 1, and a side inlet 31 of said water tank 3 corresponds to a water-pouring entrance 12 on said top of said main body 1 for a tank cap 32 press-fitted therein, as shown in FIGS. 1 and 4. In addition, an electric heating pipe 33 is attached to a bottom of said water tank 3, and a lower opening of said main body 1 is directionally secured onto a base 13.

The blending/cooking cup assembly 7 comprises a bottom slot 41 formed on a bottom portion of a cup 4 and engaged against a corresponding circular protruding edge 14 on said top of said main body 1, as shown in FIGS. 1 and 5. In addition, a cutting blade 5 is inserted from a top opening of said cup 4 and attached onto said motor axle 21 protruding outward on said top of said main body 1, and a lid 6 covering said top opening of said cup 4. As shown in FIG. 1, the present invention is characterized in that:

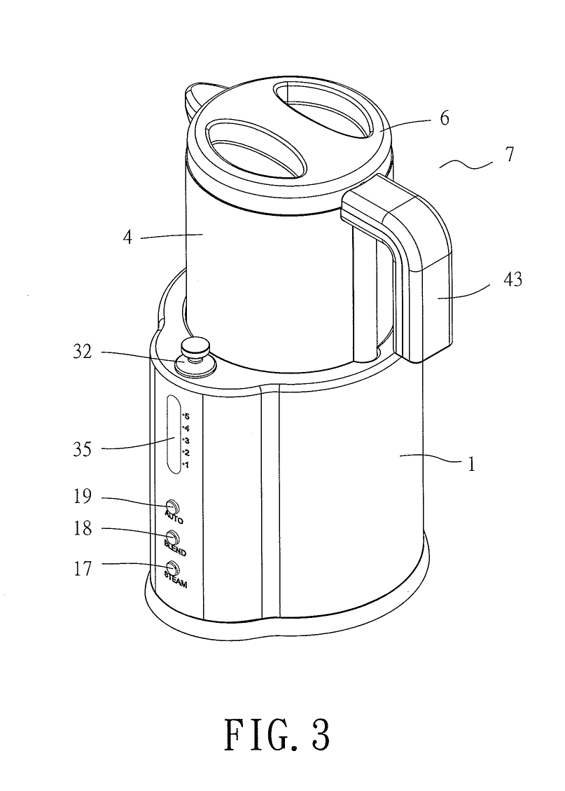

The water tank 3 attached to said internal of said main body 1 comprises a predefined water vapor outlet 34 adjacent to a top end thereof; a water vapor conduit 42 formed in a top-down direction is provided on a lateral circumference of said cup 4; said conduit 42 extends to an inner outlet 432 of a side handle 43 of said cup 4; said water vapor conduit 42 formed on said lateral circumference of said cup 4 adjacent to said top end thereof is directionally connected to said side handle 43 with said inner outlet 432 adjacent to said top of said cup 4 and penetrating an inner side of said side handle 43 formed in two halves such that said water vapor conduit 42 is guided to exit from said side handle 43 and such that said inner outlet 432 corresponds to a predefined hole 61 on said lid 6. In addition, the main body 1 attached with said water tank 3 further comprises a notch 15 formed adjacent to said water vapor outlet 34 on said top of said main body 1, corresponding to said water tank 3, such that a section of said conduit 42 on one side of cup 4 is connected firmly thereto, as shown in FIGS. 1 and 5. Furthermore, one side of said water tank 3 attached to said internal of said main body 1 comprises a transparent viewing window 35 corresponding to a predefined transparent slot 16 provided on said main body 1 for viewing a water level in said water tank 3, as shown in FIGS. 1 and 3.

Accordingly, during the operation and use of the abovementioned main body 1 and the blending/cooking cup assembly 7, as shown in FIGS. 2 and 3, food to be cooked is placed into the cup 4 of the blending/cooking cup assembly 7 and the lid 6 is then covered, following which the bottom of the blending/cooking cup assembly 7 is engaged against onto the corresponding circular protruding edge 14 on the top of the main body 1 and the tank cap 32 is opened for water to be poured into the water tank 3 at the internal of the main body 1 from the water-pouring entrance 12 thereof. Then, the user can press a number of buttons, including cooking button 17, blending button 18 and automatic button 19, provided on one side of the main body 1 in order to perform the cooking of the food contained in the cup 4. During the cooking process, as shown in FIG. 5, the water 9 filled into the water tank 3 inside the main body 1 is heated and boiled by the electric heating pipe 33 to generate water vapor 91 capable following said outlet 34 on one end of said water tank 3 into said conduit 42 on one side of said cup 4 (for the water in the water tank heated and boiled to a water level higher than the predefined level, the power of the processor is automatically cut off) and further into an internal of the cup 4 via the hole 61 provided on the lid 6 in order to cook food contained therein.

Furthermore, to perform the blending of the cooked food, one can press down the blending button 18 on one side of the main body 1 such that the food contained in the cup 4 as well as the food to be further added can be blended uniformly by the cutting blade 5 rotating at a slow speed and actuated by the main body 1.

In order to perform the grinding of the cooked food, one can press down the automatic button 19 on one side of the main body 1 such that the cooked food contained in the cup 4 can be grinded to a predefined size by the cutting blade 5 actuated by the motor 2 of the main body 1.

What is claimed is:

1. A baby food processor, comprising a main body and a grinder/cooking cup assembly; wherein a bottom portion of said main body comprises a motor having an axle protruding outward from a predefined hole on a top of said main body, a water tank is provided on a predefined circumference at an internal of said main body, a side inlet of said water tank corresponds to a water-pouring entrance on said top of said main body for a tank cap press-fitted therein, an electric heating pipe is attached to a bottom of said water tank, and a lower opening of said main body is directionally secured onto a base; and wherein said blending/cooking cup assembly comprises a bottom slot formed on a bottom portion of a cup and engaged against a corresponding circular protruding edge on said top of said main body, a cutting blade is inserted from a top opening of said cup and attached onto said motor axle protruding outward on said top of said main body, and a lid covering said top opening of said cup;
characterized in that: said water tank attached to said internal of said main body comprises a predefined water vapor outlet adjacent to a top end thereof, a water vapor conduit formed in a top-down direction is provided on a lateral circumference of said cup, and said conduit extends to an inner outlet of a side handle of said cup and said inner outlet corresponds to a predefined hole on said lid; whereby, water filled into said water tank inside said main body is heated and boiled by said electric heating pipe to generate water vapor capable following said outlet on one end of said water tank into said conduit on one side of said cup and further into an internal of said cup via said hole provided on said lid in order to cook food contained therein.

2. The baby food processor as claimed in claim 1, wherein said water vapor conduit formed on said lateral circumference of said cup adjacent to said top end thereof is directionally connected to said side handle with said inner outlet adjacent to said top of said cup and penetrating an inner side of said side handle formed in two halves such that said water vapor conduit is guided to exit from said side handle.

3. The baby food processor as claimed in claim 1, wherein said main body attached with said water tank further comprises a notch formed adjacent to said water vapor outlet on said top of said main body such that a section of said conduit on one side of cup is connected firmly thereto.

4. The baby food processor as claimed in claim 1, wherein one side of said water tank attached to said internal of said main body comprises a transparent viewing window corresponding to a predefined transparent slot provided on said main body for viewing a water level in said water tank.
